(19) United States
(12) Patent Application Publication
(10) Pub. No.: US 2011/0113090 A1
(43) Pub. Date: May 12, 2011

(54) DYNAMIC MOBILE CLIENT

(75) Inventor: Asaf Peeri, Ganot Hadar (IL)

(73) Assignee: CELLERIUM, LTD., Sde Boker (IL)

(21) Appl. No.: 12/997,926

(22) PCT Filed: Jun. 16, 2009
(86) PCT No.: PCT/IL2009/000600

§ 371 Date: Dec. 14, 2010

Related U.S. Application Data
(60) Provisional application No. 61/061,846, filed on Jun. 16, 2008.

(51) Int. Cl. G06F 15/16

(52) U.S. Cl. 709/203

(57) ABSTRACT

Apparatus for presenting a customized mobile application page on a mobile device, the apparatus includes a communication interface and a user interface functionality manager, the communication interface is coupled with a communication interface of a mobile application server, the user interface functionality manager is coupled with the communication interface, for providing the graphics of the customized mobile application page to the display of the mobile device and for implementing an event action list of each of a plurality of components of the customized mobile application page, the user interface functionality manager sends a web access request to the mobile application server via the communication interface, according to input received from a user of the mobile device, the communication interface receives the customized mobile application page from the mobile application server, the customized mobile application page corresponds to the web access request, the received customized mobile application page is adapted according to the characteristics of the mobile device, the communication interface provides the adapted customized mobile application page to the user interface functionality manager.

### FIELD OF THE DISCLOSED TECHNIQUE

The disclosed technique relates to mobile application browsing on mobile telephones, in general, and to methods and systems of creating adapted application pages to various types of cellular phone to cater for small-device user interaction, in particular.

### BACKGROUND OF THE DISCLOSED TECHNIQUE

Mobile telephones have become a part of our essential personal belongings. One application of mobile devices and personal digital assistants (PDA's) is to connect to the Internet and browse web pages. A cellular (i.e., mobile) phone potentially provides access to information available on the Web. Most Web pages, however, are designed to be presented onto a personal computer (PC).

Cellular phones (i.e., also known as cellphones or mobile phones), by virtue of their compact size, light weight, tend to come with small screens, a constrained user interface (UI) configuration, and weak processing power. Screens are typically a few centimeters in size and of low resolution. The UI configuration is improved by the addition of scroll keys and zoom keys. However, with its limited input mechanisms, the mobile surfing experience is cumbersome. Cellular phones possess a computing capability that is several orders of magnitude below that of PC's, slowing down processes. Variations from one mobile device to another, in screen length-to-width ratio, processing capabilities, input devices (such as Bluetooth, camera, Zigbee and the like), operating systems, different browsers, and so on, compound any solution to the mobile browsing problem.

There are several known methods for delivering web content on a mobile device. One method utilizes a mobile web browser, a piece of software which is installed onto the cellphone. In this method, HyperText Markup Language (HTML) and its variations (such as xHTML) pages can be accessed. Most mobile web browsers use a narrow layout, whereby the content is transposed and scaled to fit the screen width.

Another method uses a wireless application protocol (WAP). This method involves accessing specially-made web pages, written in Wireless Markup Language (WML) and requires a WAP browser installed on the mobile device. HTML pages cannot be accessed.

A further method uses content adaptation. In this method, the server analyses the web page's content, determines the meaning of each object in the page, then reformats the content according to the physical and network characteristics of the mobile device. The processor that performs the transformation produces a device-specific page.

Yet another method involves employing a mobile web application. The application is site-specific. The software is downloaded onto the mobile device. There are several ways of rendering the application suitable for a wide range of devices. One way is to produce many versions of the same application, each of which addresses a specific group of devices. In this way, an end user is asked to download a device specific application. Another way is to produce a single application, which contains the adaptations for a wide range of devices (i.e., a fat application). Similarly, the end user downloads the entire fat application to his device. The downloaded application usually contains the following modules: business logic module, communication module, image file module, and the like. The end user installs an application onto his device. When the application is altered (e.g., due to changes in the original web sites or for any other reason) the user is requested to download an update to his installed static application. Methods of browsing web pages on mobile telephones are known in the art.

U.S. Patent Application Publication 2006/0015579 A1 to Sastri entitled “Architecture and Protocol for a Wireless Communication Network to Provide Scalable Web Services to Mobile Access Devices” is directed to a network architecture system for portable wireless devices where the data computation and data storage is done at a central server. The system includes a plurality of Application Server (AS) computers, a group of core network circuits and packet services infrastructure, a PSTN/ISDN network, an IEEE802.11b/a/g wireless LAN, a plurality of cellular access networks, and an internet/intranet cloud of servers. Each AS includes a program called a Client Proxy Server (CPS) and a plurality of Device Personality Objects (DPOs). The group of core network circuits and packet services infrastructure includes a Message Switching Center (MSC). The cellular access networks include a 2G cellular access network and a 3G cellular access network. The system is used with ubiquitous mobile/wireless devices. Each mobile device has an Application Specific Device (ASD) module that identifies the particular device to the AS.

The 2G cellular access network includes a plurality of base stations and a plurality of base station controllers. The plurality of base stations is connected to the MSC. The mobile devices connect to the base stations and access resources on the AS. The heavy-duty computations and data storage are performed from the base stations through the AS, as opposed to the mobile devices themselves.

The CPS manages the application sessions for each connected mobile device. The DPOs service the various classes of mobile device. Application requests from mobile devices are routed to the appropriate DPO at the AS. The appropriate DPO creates a payload for the target web application and transmits the payload to the CPS. The CPS routes the payload to the appropriate DPO which, in turn, translates the payload into a format that is compatible with the target mobile device.

U.S. Pat. No. 7,240,327 B2 to Singh entitled “Cross-Platform Development for Devices with Heterogeneous Capabilities” is directed to a system and a method for generating software applications for a plurality of heterogeneous computing devices. The system includes a framework, a modeling tool, a plurality of object types, and an application generator. The framework includes a User Interface (UI) layer, an interaction layer, a Business Object Layer (BOL), and a data access layer (TL). The modeling tool includes a metamodeler and a modeler.

The framework provides a common architecture for the heterogeneous computing devices as well as a plurality of common services to applications running under the framework. Each computing device is associated with an application database. Each of the object types possesses a functional relationship to the common services. The metamodeler is a development tool for specifying a number of object types and defines the user interface type objects that are related to the UI layer, the BOL and the interaction layer. The UI layer functions to present a mobile user with a Graphical User Interface (GUI). The interaction layer functions to respond to interactions made by the mobile user with the user interface layer.

The BOL defines the functionality, structure and logic running on the computing devices. The modeler allows a user developer to create and to define a user interface for an application. The modeler allows the user developer to define how the TL layer interacts with the application database on the computing devices. The modeler generates metadata, which specifies to the application generator how to generate an application for a specific computing device having particular capabilities.

U.S. Pat. No. 7,143,141 B1 to Morgan entitled “System for Providing Internet-Related Services in Response to a Handheld Device that is not required to be Internet-Enabled” is directed to a system that provides internet access to a mobile device by running a client program on the device. The system includes a client device, a remote web content server, and a gateway system. The client device includes a client program. The gateway system includes a receiver, a web-access module, a rendering module, and a device-specific rendering module. The remote web content server is connected to the Internet. The web access module allows the gateway to connect with the remote web content server via the internet. The device-specific rendering module is connected with the web-access module. The receiver is connected with the web-access module and to the client device.

The client program runs on the client device. The client device sends a URL to the gateway system, requesting content. The receiver in the gateway system receives the URL from the client device. The receiver transfers the URL to the web-access module. The web access module retrieves the content from the remote content server, corresponding to that specified by the URL via the internet. The web-access module sends the content to the rendering module. The rendering module renders the retrieved contents to a user of the client device.

U.S. Pat. No. 6,300,947 B1 to Kanevsky entitled “Display Screen and Window Size Related Web Page Adaptation System” is directed to a system and method for adapting the contents and layout of a web page to match different displays and screen sizes. The system includes a server, a plurality of other servers, a client machine, and a web page adaptor server. The client machine includes a client web page adaptor module, a web browser program, and a display. The client machine is operatively coupled to the server. The server is operatively coupled to the web page adaptor server as well as to the internet. The web page adaptor server is operatively coupled with the plurality of servers.

The client machine runs the client web page adaptor module and the web browser program. The client machine sends a request message, conforming to the URL standard, and a display mode message to the server. The display mode message includes characteristics and parameters of the display on the client machine. Characteristics and parameters include display size, memory information, and operating system information. The URL request message defines a route from the server to a particular web site including a plurality of web pages. The server sends the display mode message and the contents of the web pages to the web page adaptor server.

The web page adaptor server transforms the web pages so that the contents of the web pages adapt to the requirements of the display of the client machine, as specified by the display mode message. The transformed web pages are sent to the server, then on to the client machine. The client web page adaptor module adapts the transformed web pages to the client machine. The display device displays the transformed and adapted web pages.

European Patent Application EP 1087308 A2 to Martin entitled “Method and system for providing resource access in a mobile environment” is directed to a system and method for enabling a plurality of mobile devices internet access to resources over a plurality of networks. The system includes a computer, a wireless network, a link server, a host server, a land network, and a plurality of servers for providing internet content. The system is used with a plurality of mobile devices. The mobile devices include a wireless protocol interface, and a micro-browser. The wireless network is connected with the link server which is, in turn, connected with the host server. The host server is connected with the land network which is, in turn, connected with the internet and with the computer. The mobile devices are connected with the wireless network via the wireless protocol interface.

The mobile devices send a request to the host server via the wireless network, the link server and the host server. The request includes information about the browser type and characteristics of a particular mobile device. The host server retrieves the web pages from the Internet by employing dynamic mapping of the URLs, whereby the appropriate web page is forwarded to the specific mobile device.

### SUMMARY

It is an object of the disclosed technique to provide methods and systems for producing adapted application pages to various types of cellular phones, and to cater for small-device user interaction.

In accordance with an embodiment of the disclosed technique there is thus provided an apparatus for presenting a customized mobile application page on a mobile device. The apparatus including a communication interface and a user interface functionality manager. The communication interface is coupled with a communication interface of a mobile application server. The user interface functionality manager is coupled with the communication interface, for providing the graphics of the customized mobile application page to the display of the mobile device, and for implementing an event action list of each of a plurality of components of the customized mobile application page. The user interface functionality manager sends a web access request to the mobile application server via the communication interface, according to input received from a user of the mobile device. The communication interface receives the customized mobile application page from the mobile application server. The customized mobile application page corresponds to the web access request. The received customized mobile application page is adapted according to the characteristics of the mobile device. The communication interface provides the adapted customized mobile application page to the user interface functionality manager.

In accordance with another embodiment of the disclosed technique, there is thus provided a method for presenting a customized mobile application page on a mobile device. The method includes the procedures of sending a web access request, receiving at least one adapted customized mobile application page and presenting the at least one adapted customized mobile application page. The adapted customized mobile application pages are received from the mobile application server. The adapted customized mobile application pages are adapted according to the characteristics of the mobile device. The adapted customized mobile application pages include mobile application components. Each of the mobile application components includes communications protocol and method for communicating with external systems for retrieving respective data stored thereon. The communications protocol and method further serve as complementary logic for the mobile application component. The procedure of presenting is performed by employing the mobile device.

In accordance with a further embodiment of the disclosed technique, there is thus provided an apparatus for adapting a customized mobile application page and providing it to a mobile device. The apparatus includes a communication interface, an administrator and an adaptor. The communication interface is coupled with a communication interface of the mobile device. The administrator is coupled with the communication interface, for retrieving the customized mobile application page from a database. The customized mobile application page corresponds to the web access request. The adaptor adapts the customized mobile application page according to the characteristics of the mobile device. The communication interface receives the web access request from the mobile device. The communication interface provides the web access request to the administrator. The administrator provides the customized mobile application page to the adaptor. The adaptor provides the adapted mobile application page to the mobile device via the communication interface.

In accordance with yet another embodiment of the disclosed technique, there is thus provided a method for adapting a customized mobile application page according to the characteristics of a mobile device and for providing the customized mobile application page to the mobile device. The method includes the procedures of receiving a web access request from the mobile device, retrieving a customized mobile application page, adapting the customized mobile application page and providing the customized mobile application page to the mobile device. The customized mobile application page corresponds to the web access request. The customized mobile application page includes mobile application components. Each of the mobile application components includes communications protocol and method for communicating with external systems for retrieving respective data stored on the external system. The communications protocol and method further serve as complementary logic for the mobile application component. The procedure of adapting is performed according to the characteristics of the mobile device.

In accordance with yet a further embodiment of the disclosed technique, there is thus provided a method for producing a customized mobile application page. The method includes the procedures of receiving instructions, receiving the type of a new mobile application component, receiving the design of the new mobile application component, associating communication protocol and method, associating complementary logic and data and receiving the behaviour of the new component. The instructions are for generating a new customized mobile application page and the design thereof. The component type is of a predetermined list of component types. The communication protocol and method are associated with the new component. The complementary logic and data are associated with the new component in accordance with the communications protocol and method. The procedure of receiving the type of a new component, receiving the design, associating communication protocol, associating complementary logic, and receiving the behaviour are repeated for each of the components of the customized mobile application page.

### BRIEF DESCRIPTION OF THE DRAWINGS

The disclosed technique will be understood and appreciated more fully from the following detailed description taken in conjunction with the drawings in which:

FIG. 1 is a schematic illustration of two regular web pages, a customized mobile application page, and their complementary web server and mobile application server, constructed and operative in accordance with an embodiment of the disclosed technique;

FIG. 2 is a schematic illustration of a system for producing and presenting customized mobile application pages to a user of a cellular phone, adapted according to the characteristics of the cellular phone, constructed and operative in accordance with another embodiment of the disclosed technique;

FIG. 3A is a schematic illustration of a system for enabling interaction between a cellular phone, a dynamic mobile client, and mobile application server, constructed and operative in accordance with a further embodiment of the disclosed technique;

FIG. 3B is a schematic illustration of the system of FIG. 4A, in which the mobile application server sends customized mobile application pages to the dynamic mobile client;

FIG. 3C is a schematic illustration of the system of FIG. 4A, in which the dynamic mobile client sends user input to the mobile application server;

FIG. 3D is a schematic illustration of the system of FIG. 4A, in which the mobile application server sends further customized mobile application pages and dynamic data to the dynamic mobile client;

FIG. 4 is a schematic illustration of the inner modules of each of the elements of the system of FIG. 3, constructed and operative in accordance with another embodiment of the disclosed technique;

FIG. 5 is a schematic illustration of a method for operating a mobile application studio for creating customized mobile applications, operative in accordance with a further embodiment of the disclosed technique;

FIG. 6 is a schematic illustration of a method for operating a mobile application server, operative in accordance with another embodiment of the disclosed technique;

FIG. 7 is a schematic illustration of a method for operating a dynamic mobile client, operative in accordance with a further embodiment of the disclosed technique; and

FIG. 8 is a schematic illustration of a method for determining the characteristics of a cellular phone, operative in accordance with another embodiment of the disclosed technique.

### DETAILED DESCRIPTION OF THE EMBODIMENTS

The disclosed technique overcomes the disadvantages of the prior art by providing a system which includes a cellular phone with a dynamic mobile client installed thereon, and a cellular-application intermediate web server (i.e., mobile application server). The dynamic mobile client discovers the characteristics of the cellular phone and sends the characteristics to the mobile application server. The dynamic mobile client further sends a web access request to the mobile application server. The mobile application server retrieves customized mobile application pages, defined herein below, in response to the web access request, and adapts the customized mobile application pages to match the characteristics of the cellular phone. The mobile application server sends the customized mobile application pages to the dynamic mobile client. The dynamic mobile client presents the customized mobile application pages to the user of the cellular phone and enables navigation within and through the customized mobile application pages by means of the cellular phone.

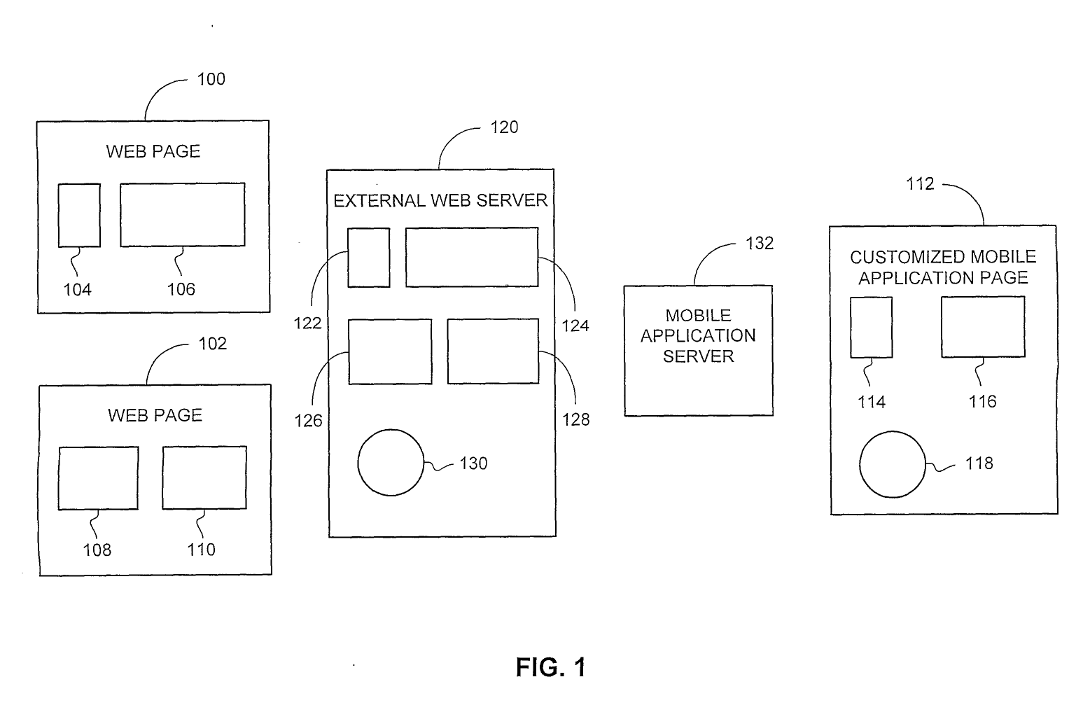

Reference is now made to FIG. 1, which is a schematic illustration of two regular web pages, referenced 100 and 102, a customized mobile application page, referenced 112, and their complementary web server and mobile application server, constructed and operative in accordance with an embodiment of the disclosed technique. First regular web page 100 includes a first component 104 and a second component 106. Second regular web page 102 includes a third component 108 and a fourth component 110. Customized mobile application page 112 includes mobile application components 114, 116 and 118. External web server 120 includes complementary logic 122, 124, 126, 128 and 130.

Regular web pages 100 and 102 are web pages as known in the art. First component 104, second component 106, third component 108, and fourth component 110 are web page components as known in the art. Complementary logic 122 is related to first component 104, such that it includes the logic supporting all the processing related to first component 104. For example, complementary logic 122 contains the business logic of first component 104 (i.e., functional algorithms which handle data and information received from the user interface), the ability to access databases, and the like. In a similar manner, each of second component 106, third component 108, and fourth component 110, is related to each of complementary logic 124, complementary logic 126, and complementary logic 128, respectively.

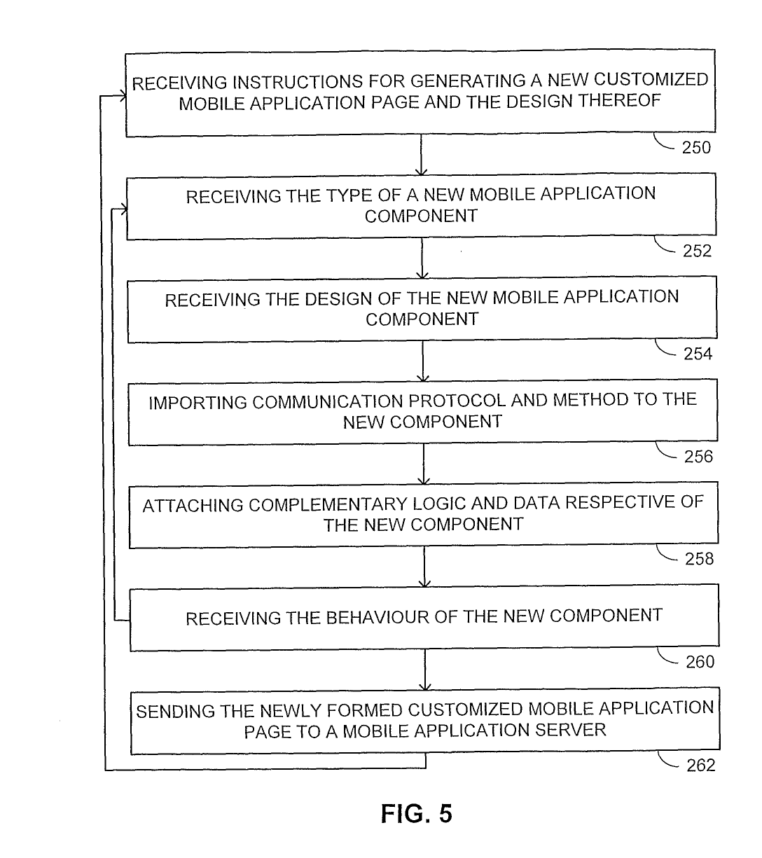

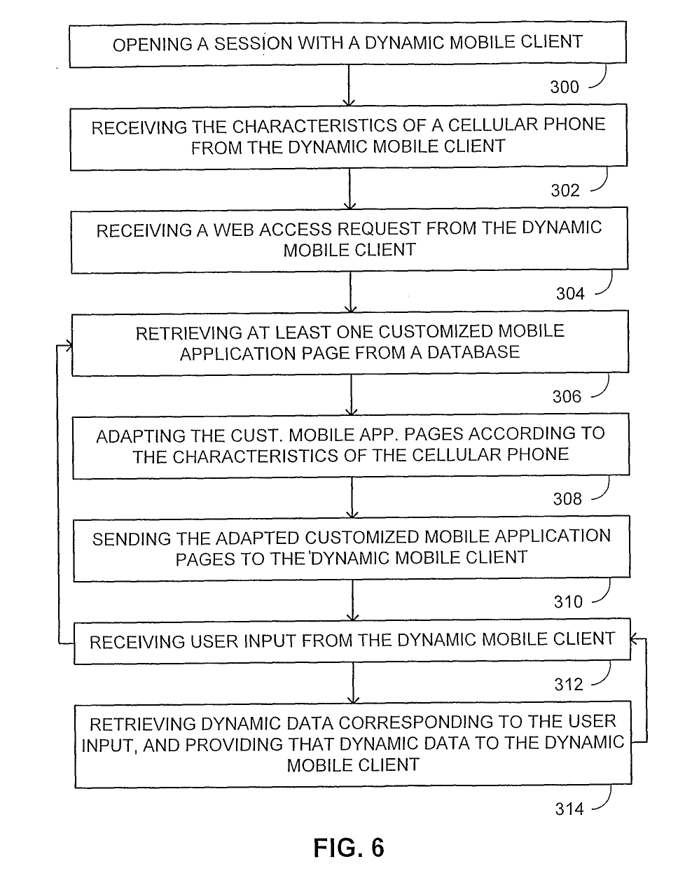

A user of a mobile application studio produces customized mobile application page 112 and stores it on mobile application server 132 as detailed further herein below with reference to FIG. 5. Mobile application server 132 sends customized mobile application page 112 to a cellular phone as detailed further with reference to FIG. 6. Customized mobile application page 112 contains internal properties, such as UI (e.g., background colour and image, page alignment), data (e.g., page name and description, next/previous page), and behaviour thereof (e.g., refresh rate, encryption). Customized mobile application page 112 further includes components and the internal properties thereof. Every processing operation, script, business logic and database related to customized mobile application page 112 is located and performed on external web server 120 and is accessed through mobile application server 132 as detailed further with reference to FIG. 6. In this manner, customized mobile application page 112 requires only meager resources from the cellular phone.

Each of mobile application components 114, 116, and 118, contains information pertaining to the appearance (e.g., position, shape, size, colour) and behaviour thereof (i.e., event-action list—as detailed further with reference to FIG. 5). Each of mobile application components 114, 116, and 118, further includes either data or a pointer (e.g., Application Programming Interface—API, Web Service, Uniform Resource Locator connection—URL, and the like), pointing to the data source. Each of mobile application components 114, 116, and 118, is related to complementary logics 122, 126, and 130, respectively. It is noted that mobile application component 114 and component 104 are both related to the same complementary logic 122. Mobile application component 114 and component 104 have substantially similar input and output. Mobile application component 116 and component 108 are both related to the same complementary logic 126. Mobile application component 116 and component 108 have substantially similar input and output. Alternatively, some of the mobile application components are not related to any complementary logic. For example, mobile application component 118 is not related to complementary logic 130.

It is further noted that customized mobile application page 112 contains mobile application components that share the same complementary logic as regular components of different regular web pages (i.e., mobile application component 114 shares complementary logic 122 with regular component 104 of regular web page 100, mobile application component 116 shares complementary logic 126 with regular component 108 of regular web page 102, and mobile application component 118 is related to complementary logic 130, which relates neither to a component of web page 100 nor to a component of web page 102).

External web server 120 is a regular web server as known in the art. External web server 120 can represent a plurality of external web servers such that each of complementary logic 122, 124, 126, 128, and 130 resides on a different external web server. External web server 120 receives input by way of data and a navigation command (e.g., a mouse click) from web page 100, web page 102, and customized mobile application page 120 via mobile application server 132. External web server provides output (e.g., data, an image, a link to another web page) corresponding to the received input.

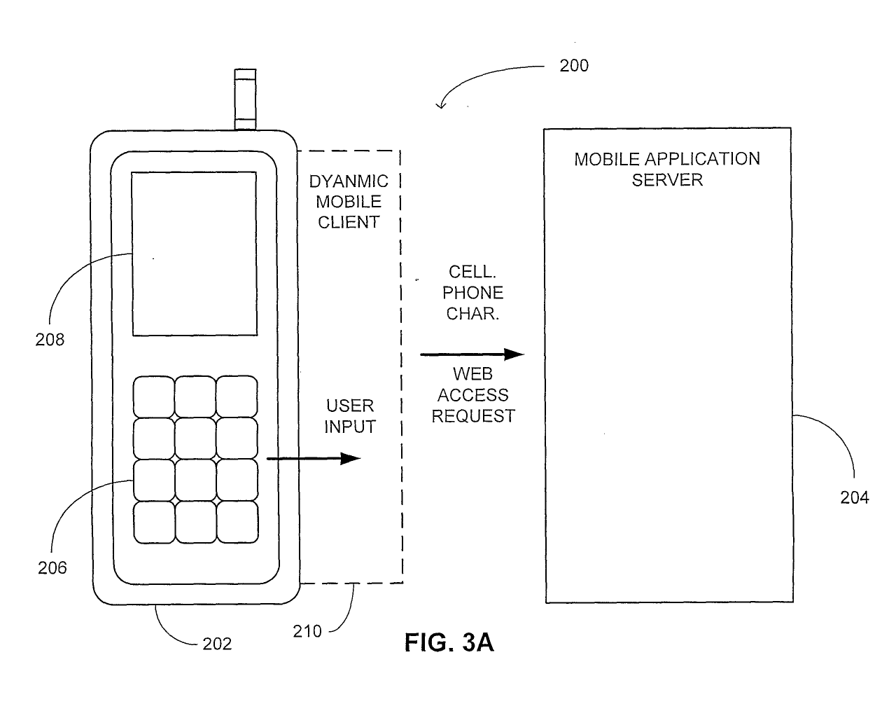

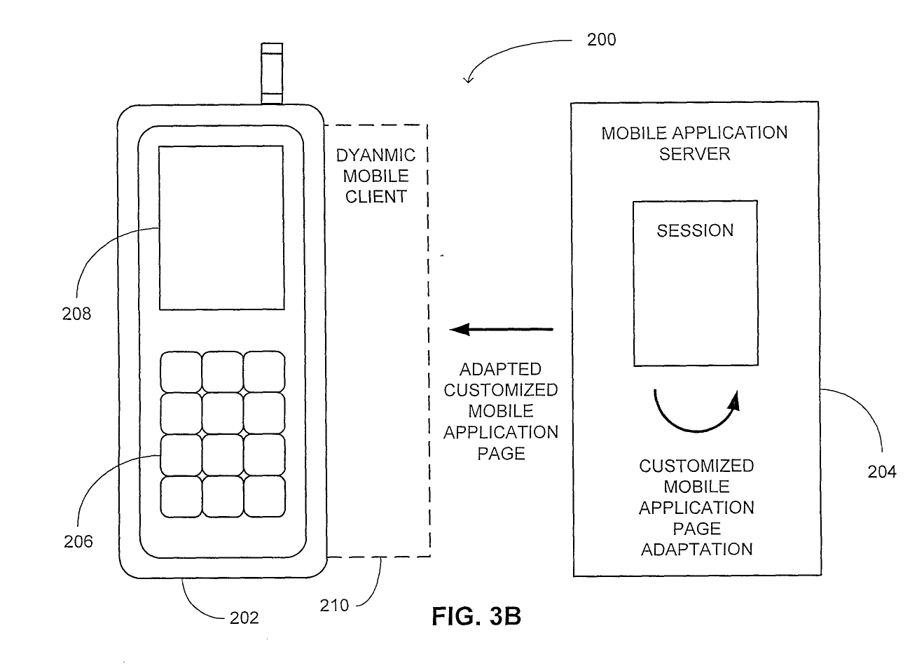

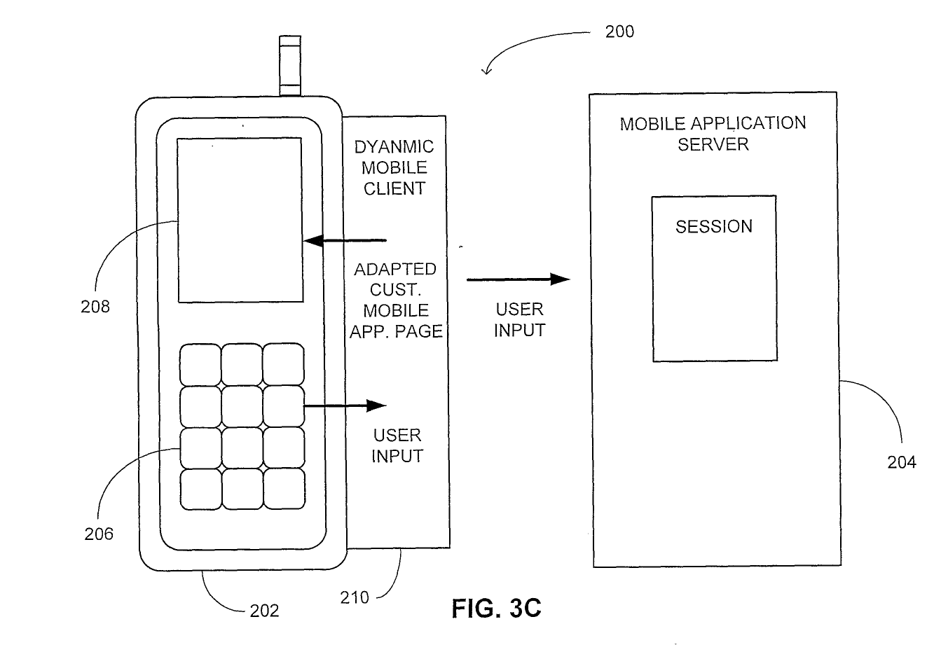

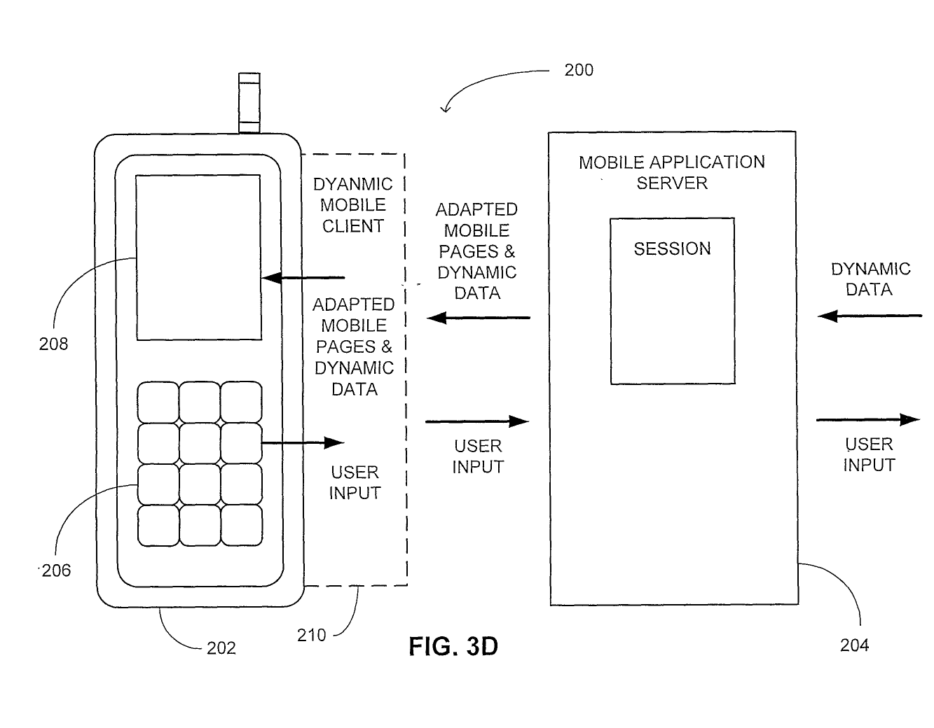

Reference is now made to FIG. 3, which is a schematic illustration of a system, generally referenced 150, for producing and presenting customized mobile application pages to a user of a cellular phone (i.e., cellular user), adapted according to the characteristics of the cellular phone, constructed and operative in accordance with another embodiment of the disclosed technique. System 150 includes a cellular phone 152, a cellular-application intermediate web server 154 (i.e., mobile application server 154), and a cellular-application studio 156. Cellular phone 152 is coupled, via a network (e.g., cellular network, Bluetooth, Wi-Fi, Zigbee), with mobile application server 154. Mobile application server 154 is coupled with cellular-application studio 156 and with the web 158.

Mobile application server 154 stores customized mobile application pages (i.e., on a database—not shown), produced on cellular-application studio 156. It is noted that a database is any memory means known in the art, such as electromagnetic media (e.g., hard disk, audio tape player, and video tape player), either volatile or non-volatile electronic media (e.g., random access memory microchip—RAM microchip), and optical media (e.g., compact disk—CD, digital versatile disk—DVD, and holographic versatile disk—HVD).

A dynamic mobile client 160 is installed on cellular phone 152 according to the operating platform of that cellular phone (i.e., there is a specific dynamic mobile client for every operating platform). Alternatively, dynamic mobile client 160 is simply downloaded to cellular phone 152 and requires no installation. Dynamic mobile client 160 sends data to, and receives data from, mobile application server 154. Dynamic mobile client 160 sends a web access request to mobile application server 154.

Mobile application server 154 retrieves customized mobile application pages corresponding to the web access request of dynamic mobile client 160. Mobile application server 154 adapts the customized mobile application pages to match the characteristics and capabilities of cellular phone 152, and sends the adapted customized mobile application pages to dynamic mobile client 160. Alternatively, an adapted customized mobile application page, corresponding to the web access request of dynamic mobile client 160, pre-exists (e.g., from a previous session) on the memory of cellular phone 152 (e.g., volatile memory and non-volatile memory). Dynamic mobile client 160 presents the adapted mobile application pages, and enables the cellular user to navigate through and within the customized mobile application pages and to provide user input to mobile application server 154.

Reference is now made to FIGS. 3A, 3B, 3C, and 3D. FIG. 3A is a schematic illustration of a system, generally referenced 150, for enabling interaction between a cellular phone, a dynamic mobile client, and mobile application server, constructed and operative in accordance with a further embodiment of the disclosed technique. FIG. 3B is a schematic illustration of the system of FIG. 3A, in which the mobile application server sends customized mobile application pages to the dynamic mobile client. FIG. 3C is a schematic illustration of the system of FIG. 3A, in which the dynamic mobile client sends user input to the mobile application server. FIG. 3D is a schematic illustration of the system of FIG. 3A, in which the mobile application server sends further customized mobile application pages and dynamic data to the dynamic mobile client.

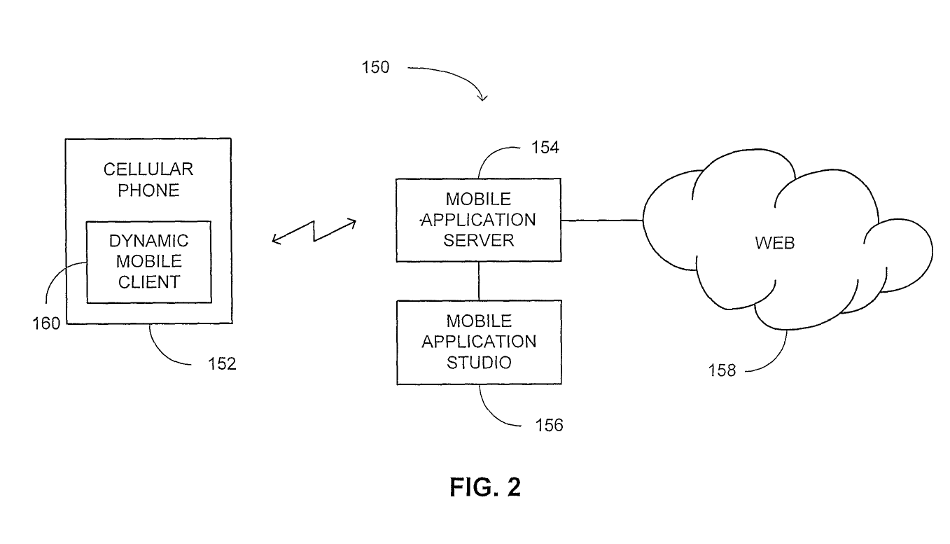

With reference to FIG. 3A, system 200 includes a cellular phone 202 and a cellular-application intermediate web server 204 (i.e., mobile application server 204). A dynamic mobile client 210 is installed on cellular phone 202. Cellular phone 202, mobile application server 204 and dynamic mobile client 210 are substantially similar to cellular phone 152, mobile application server 154, and dynamic mobile client 160 of FIG. 2.

Cellular phone 202 includes a keypad 206, and a screen 208. Dynamic mobile client 210 is coupled with keypad 206 and with screen 208. A user of cellular phone 202 (i.e., a cellular user) employs keypad 206 for inputting commands and data. It is noted that, keypad 206 can be either replaced or augmented by any input interface known in the art, such as a keypad, a qwerty keypad, a track-wheel, a trackball, a joystick, a scroll-wheel, a touch-pad, a touch screen, a pointing device, a stylus and the like.

Screen 208 displays information received from dynamic mobile client 210. It is noted that, screen 208 can either be replaced or augmented by any output interface known in the art, such as a speaker, a tactile device, and the like. Dynamic mobile client 210 mediates incoming and outgoing data to and from cellular phone 202.

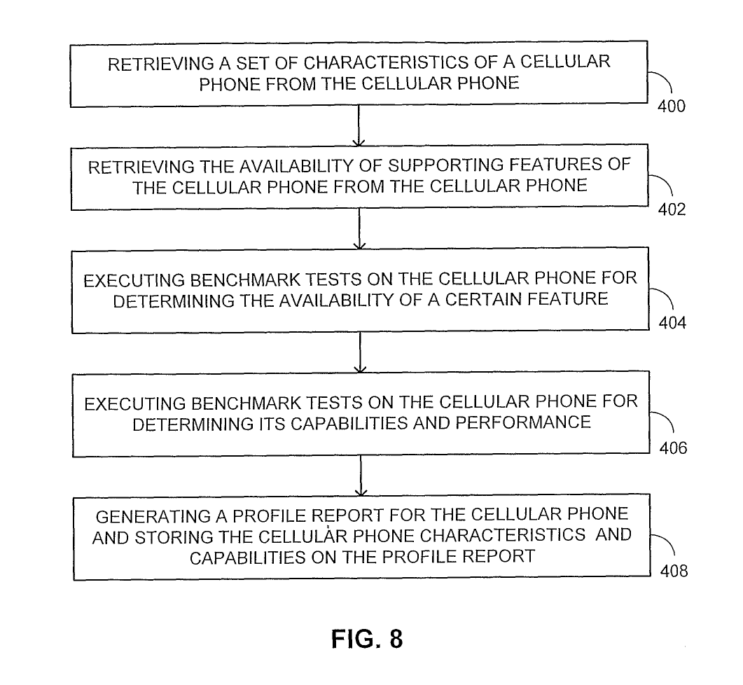

When the cellular user activates dynamic mobile client 210 for the first time, dynamic mobile client 210 discovers the characteristics of cellular phone 202 as detailed further with reference to FIG. 8, and sends the characteristics of cellular phone 202 to mobile application server 204. Mobile application server 204 stores the characteristics of cellular phone 202. When the cellular user activates dynamic mobile client 210, a first web access request is generated by dynamic mobile client 210 and sent to mobile application server 204 (i.e., the initial web access request is determined according to the web application the cellular user wishes to access). It is noted that, mobile application server 204 uniquely identifies dynamic mobile client 210 each time a session is opened.

With reference to FIG. 3B, mobile application server 204 receives cellular phone characteristics and the first web access request from dynamic mobile client 210, and opens a session with dynamic mobile client 210. Mobile application server 204 retrieves a customized mobile application page (e.g., customized mobile application page 114 of FIG. 1), corresponding to the first web access request. Mobile application server 204 adapts the customized mobile application page to match the characteristics of cellular phone 202. Mobile application server 204 sends the adapted customized mobile application page to dynamic mobile client 210.

With reference to FIG. 3C, dynamic mobile client 210 receives the adapted customized mobile application page from mobile application server 204. Dynamic mobile client 210 presents the customized mobile application page to the cellular user, via screen 208. The cellular user inputs commands and data by employing keypad 206 (i.e., cellular user input consisting of data and navigation commands such as clicking a component, and the like). Dynamic mobile client 210 receives the cellular user input. Dynamic mobile client 210 sends the user input to mobile application server 204 with which it has an open session.

With reference to FIG. 3D, mobile application server 204 receives user input, and sends that user input to an external web server (not shown) to fetch the complementary logic corresponding to the currently presented customized mobile application page (e.g., external web server 120 contains the business logic of customized mobile application page 112). The external web server receives the user input and processes the user input. The corresponding web server provides corresponding output (e.g., data, validation errors, and the like) to mobile application server 204. Mobile application server 204 adapts the output and sends it to dynamic mobile client 210. Dynamic mobile client 210 receives the adapted output, further adapts it if necessary, and presents it via screen 208.

Dynamic mobile client 210 receives further input from the cellular user, via keypad 206, and sends that input to mobile application server 204, as detailed herein above. The session of mobile application server 204 remains open and dynamic mobile client 210 mediates data flow between cellular phone 202 and mobile application server 204, triggered by user input or by automatic events (e.g., auto-refresh) until the session is terminated.

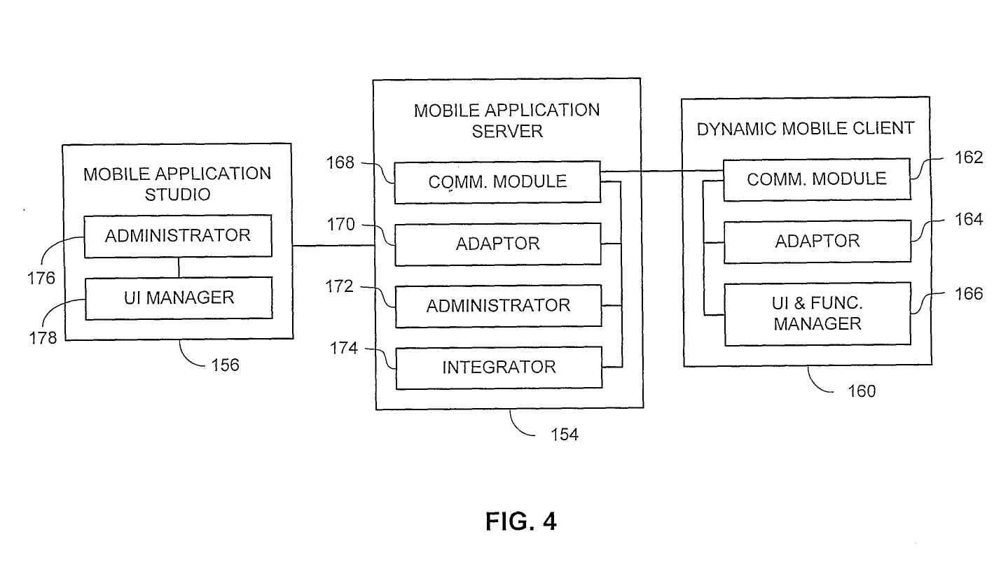

Reference is now made to FIG. 4, which is a schematic illustration of the inner modules of each of the elements of system 150 of FIG. 2, constructed and operative in accordance with another embodiment of the disclosed technique. Cellular-application studio 156 includes an administrator 176 and a User Interface (UI) manager 178. Administrator 176 and UI manager 178 are coupled together. Dynamic mobile client 160 includes a communication interface 162, an adaptor 164, and a User Interface Functionality (UIF) manager 166. Communication interface 162, adaptor 164, and UIF manager 166 are all coupled there-between.

Mobile application server 154 includes a communication interface 168, an adaptor 170, an administrator 172, and an integrator 174. Communication interface 168, adaptor 170, administrator 172, and integrator 174 are all coupled there-between. Communication interface 162 of dynamic mobile client 160 is coupled with communication interface 168 of mobile application server 154. Cellular-application studio 156 is coupled with mobile application server 154.

UI manager 178 provides a set of design tools for production of a customized mobile application page (e.g., customized mobile application page 112 of FIG. 1). A user of cellular-application studio 156 (i.e., a studio user) employs the design tools of UI manager 178 for designing a user interface layer of the customized mobile application page.

Administrator 176 gathers data respective of the customized mobile application page into logical data units, and sends the data to administrator 172 of mobile application server 154. The operation of cellular-application studio 156 is detailed further herein below with reference to FIG. 5. Dynamic mobile client 160 is downloaded and installed onto cellular phone 152 (FIG. 2). Dynamic mobile client 160 discovers the characteristics and capabilities of cellular phone 152, as detailed further with reference to FIG. 8, herein below. The characteristics and capabilities of cellular phone 152 include all the attributes which differ between mobile devices, such screen resolution, screen orientation—portrait or landscape, UserAgent String, character encoding, current locale, supported configuration, list of communication ports, supported video capture formats, supported image capture formats, total amount of memory, graphics memory, CPU performance, input devices, supported functionalities such as video camera, Bluetooth, audio recorder, accelerometer, GPS, speaker, infra-red, radio, digital compass, vibrator, WiFi, WiMax, and the like. Dynamic mobile client 160 sends the characteristics and capabilities of cellular phone 152 to mobile application server 154. Dynamic mobile client 160 sends a web access request to mobile application server 154.

Dynamic mobile client 160 receives customized mobile application pages, adapted to cellular phone 152, from mobile application server 154, and presents, via cellular phone 152, the adapted customized mobile application pages to a user of cellular phone 152 (i.e., cellular user). Dynamic mobile client 160 further enables the cellular user to navigate through and within the adapted customized mobile application pages according to the navigation capabilities of cellular phone 152 (e.g., keypad, scroll keys, a touch screen, and the like).

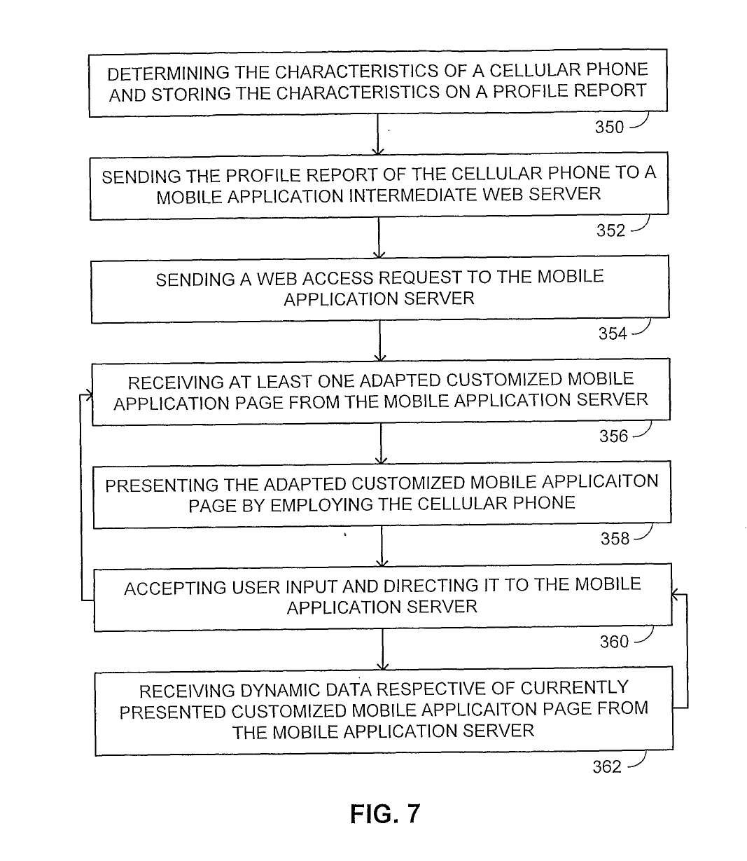

Communication interface 162 connects to communication interface 168 of mobile application server 154 for sending and receiving data (e.g., sending cellular phone characteristics and a web access request, and receiving adapted customized mobile application pages). Adaptor 164 is an optional complementary solution to the adaptation already performed by mobile application server 154 (e.g., adaptor 164 determines whether cellular phone 152 enables certain features required by the customized mobile application page). UIF manager 166 provides the graphics and the displayed data of the customized mobile application page to the display of cellular phone 152, and implements an event-action list (i.e., the event-action list is created at cellular-application studio 156, as detailed further with reference to FIG. 5) for each of the components of the customized mobile application page. The operation of dynamic mobile client 160 is detailed further herein below with reference to FIG. 7.

Administrator 172 receives a customized mobile application page from cellular-application studio 156, and stores the customized mobile application page on a database (not shown—as defined further with reference to FIG. 2). Communication interface 168 communicates (i.e., sends and receives data, such as receiving cellular phone characteristics and a web access request and sending adapted customized mobile application pages and data) with communication interface 162 of dynamic mobile client 160. Administrator 172 further retrieves a customized mobile application page from the database upon a web access request from dynamic mobile client 160.

Integrator 174 communicates with external systems (i.e., by a communications protocol, such as a web service, a SOAP connection, an FTP connection, a Telnet connection, an SSH connection, an RMI connection, a Database query, an LDAP query, a REST connection, a Uniform Resource Locator connection—URL, a Really Simple Syndication—RSS, an Extensible Markup Language—XML, and the like) for retrieving complementary logic respective of the customized mobile application page and for retrieving dynamic data respective of the customized mobile application page. Integrator 174 retrieves complementary logic and dynamic data from at least one external server. Each of the external systems operates according to a specific communications protocol and method. Integrator 174 includes a communications protocol and methods repository (not shown). A studio user employs UI manager 178 for importing a communications protocol and methods, appropriate for the external system from which he wishes to retrieve data, into the communications protocol and methods repository. Adaptor 170 adapts the customized mobile application page to cellular phone 152 according to the characteristics of cellular phone 152. The operation of mobile application server 154 is further detailed herein below with reference to FIG. 6.

Reference is now made to FIG. 5, which is a schematic illustration of a method for operating a studio (e.g., cellular-application studio 156 of FIG. 2) for creating customized mobile applications, operative in accordance with a further embodiment of the disclosed technique. A customized mobile application includes at least one customized mobile application page. Each of the customized mobile application pages includes at least one component.

In procedure 250, instructions for generating a new customized mobile application page and the design thereof are received. With reference to FIGS. 1, 2 and 4, a user, operating cellular-application studio 156 (i.e., studio user), provides instructions for generating a new customized mobile application page 112. The studio user further determines the design of customized mobile application page 112 by determining the properties thereof from a list (e.g., the studio user determines a background image and colour of customized mobile application page 112). The studio user can be a regular web application developer (i.e., a webmaster, an application designer, a system analyst, and the like). The studio user is not required to have knowledge in application development, or mobile application development in order to create applications using the studio. The studio user employs mobile application studio for producing the customized mobile application by employing drag and drop techniques on cellular-application studio 156.

In procedure 252, the type of a new mobile application component is received. A type of component is selected from a list of predetermined component types in the cellular application tools. Each of the component types includes properties, such as design properties (e.g., size, location, and the like), data properties (e.g., value, marking type, security type, and the like) and behavior properties (e.g., event-action list, moving direction, focus, and the like). It is noted that all types of components include some of the properties (e.g., component size and location). It is further noted that different component types may includes different properties.

Some examples of component types are: “label” which includes properties such as Text—containing the displayed text, and “image” which includes properties such as Image—containing the displayed image and Rollover Image—containing an alternate image that is displayed in response to an event (e.g., mouse-over). Further examples are: “textbox” which includes properties such as Text and Note—a text which is displayed when there is no value at the Text property, and “link” which includes properties such as URL—containing the URL of the external web page to go to when clicking the link. Yet other examples of components types are, a ticker, an item-list, a dropdown list box, a media player, a matrix table, a radio button, a checkbox, and a command button.

With reference to FIGS. 1 and 2, a desired mobile application component type is selected from a list of component types of the mobile application studio. For example, mobile application component 114 is selected to be a “Label” component.

In procedure 254, the design of the new component is received. The values of the design properties of the new mobile application component (e.g., shape, size, location, colour, and the like) are selected. With reference to FIGS. 1 and 2, the values of the design properties of first mobile application component 114 are selected. For example the border color of first mobile application component 114 is selected to be black.

In procedure 256, a communications protocol and method, appropriate for the new component, are imported. The communications protocol is the means of communication of the external system. The method is the initiator of the action on the external server. For example, the studio user employs the mobile application studio for importing a web service (i.e., the protocol) and a call to “get person details” (i.e., the method). Another example is the studio user employing the mobile application studio for importing a URL (i.e., the protocol) and an extraction of the “<person> XML tag from within the result (i.e., the method). The component communicates with the external system by employing the appropriate communications protocol and method for retrieving complimentary logic and respective data. The communications protocol and method, appropriate for the new component, are selected according to the external system with which the new component communicates. With reference to FIGS. 1, 2 and 4, the studio user employs mobile application studio 154 for importing a communications protocol and its methods, which are employed by external server 120, into communication protocol and methods repository of integrator 174.

In procedure 258, complementary logic (i.e., as detailed herein above with reference to integrator 174 of FIG. 4) and data respective of the new component are associated with the new component. A communications protocol and method, appropriate for the new component, are associated with the new component (i.e., according to the external system the new component is communicating with). The communication protocol and method serve as the complementary logic of the new component, as well as for retrieving data respective of the new component from the corresponding external system.

The new component can display data. The data of the component can be either static data or dynamic data. Static data is data that the studio user provides during the process of generating the new customized mobile application page. The studio user either uploads or inserts the static data. Static data remains unchanged during a session between the dynamic mobile client and the mobile application server.

Dynamic data is data that is provided by an external source (i.e., by employing the communications protocol and method), an internal parameter, and the like. An internal parameter is a variable which holds a data value for the duration of the session between the dynamic mobile client and the mobile application server (e.g., a user name, a user ID number, an image). Dynamic data changes during the session. With reference to FIGS. 1, 2 and 4, First mobile application component 114 is provided with an appropriate communications protocol and method according to the external system with which first mobile application component 114 is communicating. First mobile application component 114 is further provided with respective data. The studio user provides respective data that is either static data or dynamic data.

It is noted that a secure connection with the external source can be established via common security protocols (e.g., SSL—Secure Socket Layer). The secure connection is directed at preventing the capturing of data passed between the dynamic mobile client and the mobile application server by a third party. The secure connection can be either for an entire customized mobile application page or for a single mobile application component within a customized mobile application page.

In procedure 260, the behaviour of the new component is received. Component behaviour is an event-action list which includes at least one action for each of a plurality of predetermined events taken by a user navigating through a customized mobile application page, corresponding to that component. Alternatively, the component behaviour includes a list of component events. Additionally, each of the events in each of the components events list is respective of at least one action as detailed in a general action-event list. The customized mobile application can also automatically generate events, such as an on timer event which is generated at a predetermined time, or an on error event which is generated following an error in the customized mobile application.

Some examples of events are mouse-over event, focus event, click event, change event, component load event, page load event, page unload event, container click event, has next page event, has previous page event, and the like. Some examples of actions are displaying a text box, calling an external service, setting a value of a session parameter, clearing pages from the client cache repository, going a page back in the history stack, changing a component value, changing a component design attribute, activating an API call, requesting another predetermined customized mobile application page, displaying tool-tips, bringing up a popup box, refreshing a specific component, activating an API call and the like. With reference to FIGS. 1, 2 and 4, the studio user determines the event-action list of first mobile application component 114. After procedure 258, procedures 252 to 258 are repeated until all the design, communication and methods, data and event-actions for the components on the customized mobile application page that the studio user wishes to activate are completed.

In procedure 262, the completed customized mobile application page (i.e., the new customized mobile application page including all of its components) is stored on a mobile application server. With reference to FIGS. 1, 2 and 4, the studio user completes customized mobile application page 112 including components 114, 116 and 118. The studio user sends customized mobile application page 112 to mobile application server 154. Mobile application server 154 stores customized mobile application page 112 on a database (not shown). Once procedure 262 is complete, procedures 250 to 262 are repeated until all the pages, together with all of their components, of the customized mobile application are completed. It is noted that, when the studio user employs mobile application studio 156 for producing a mobile application component which might not work on specific cellular phone types, mobile application studio 156 sends a corresponding warning to the cellular user.

Reference is now made to FIG. 6, which is a schematic illustration of a method for operating a mobile application server (e.g., mobile application server 154 of FIG. 2), operative in accordance with another embodiment of the disclosed technique. In procedure 300, a session with a dynamic mobile client is opened. With reference to FIG. 2, the cellular user activates dynamic mobile client 160. Dynamic mobile client 160 contacts mobile application server 154. Mobile application server 154 opens a session with dynamic mobile client 160 (i.e., a session with the cellular user, operating cellular phone 152).

In procedure 302, the characteristics of a cellular phone are received from the dynamic mobile client installed on that cellular phone. With reference to FIG. 2, dynamic mobile client 160 discovers the characteristics of cellular phone 152, as detailed further with reference to FIG. 8, and sends the characteristics of cellular phone 152 to mobile application server 154. It is noted that, procedure 302 is typically performed the first time the cellular user activates dynamic mobile client 160. Once cellular server 154 is familiar with cellular phone 152, procedure 302 is optional and can be performed again later (e.g., at predetermined time intervals).

In procedure 304, a web access request is received from the dynamic mobile client. With reference to FIG. 2, dynamic mobile client 160 generates a web access request corresponding to the input of the cellular user. For example, when the cellular user activates dynamic mobile client 160, an initial web access request is generated. The initial web access request is determined according to the customized mobile application the cellular user accesses.

In procedure 306, at least one customized mobile application page is retrieved from a database by the mobile application server. With reference to FIG. 2, mobile application server 154 retrieves at least one customized mobile application page from the database. Additionally, mobile application server 154 retrieves dynamic data respective of the corresponding customized mobile application pages.

In procedure 308, the customized mobile application pages (i.e., the at least one customized mobile application page) are adapted according to the characteristics of the cellular phone. With reference to FIG. 2, mobile application server 154 adapts the customized mobile application pages according to the characteristics of cellular phone 152. It is noted that, mobile application server 154 can store the adapted customized mobile application page on the database. Mobile application server 154 retrieves the adapted customized mobile application page when a dynamic mobile client installed on a cellular phone having similar characteristics requests the same customized mobile application page.

Alternatively, mobile application server 154 adapts the customized mobile application pages to match a wide variety of cellular phones upon receipt of the customized mobile application pages from cellular-application studio 156. In other words, the first time the studio user sends a customized mobile application page to mobile application server 154, mobile application server 154 prepares a plurality of versions of the customized mobile application page, adapted to a variety of cellular phone characteristics. In such a case, mobile application server 154 needs not repeat the adaptation of the customized mobile application page, and can simply locate the adapted version of the customized mobile application page, appropriate for the characteristics of cellular phone 152.

In procedure 310, the adapted, customized mobile application pages are sent to the dynamic mobile client for presentation on the cellular phone. With reference to FIG. 2, mobile application server 154 sends the adapted customized mobile application pages to dynamic mobile client 160 for presentation on cellular phone 152.

In procedure 312, input is received from the dynamic mobile client. The input from the dynamic mobile client can be data requested on the current customized mobile application page (e.g., username), a request for another customized mobile application page, an event generated by the cellular user (e.g., clicking a component) which causes an action, and the like. With reference to FIG. 2, the cellular user provides input to dynamic mobile client 160 via cellular phone 152 (e.g., the cellular user enters his username or clicks a component). Dynamic mobile client 160 sends the input of the cellular user to mobile application server 154. When the user input relates to dynamic data respective of the currently presented customized mobile application page, procedure 314 is performed after procedure 312. When the user input relates to a new customized mobile application page request, procedures 306 to 310 are performed after procedure 312.

In procedure 314, dynamic data is retrieved by the mobile application server, and provided to the dynamic mobile client for presentation. With reference to FIGS. 1 and 2, mobile application server 154 retrieves dynamic data respective of the cellular user input from an external source or an internal parameter. Mobile application server 154 adapts the dynamic data to match the characteristics of cellular phone 152. Mobile application server 154 provides the dynamic data to dynamic mobile client 160.

After the completion of procedure 314, procedure 312 is repeated. The session of mobile application server 154 with dynamic mobile client 160 continues for as long as the cellular user navigates through the application or until the session is terminated. Such that, data flows from dynamic mobile client 160 (i.e., user input) to mobile application server 154, and back (i.e., customized mobile application pages and dynamic data).

Reference is now made to FIG. 7, which is a schematic illustration of a method for operating a dynamic mobile client (e.g., dynamic mobile client 160 of FIG. 2), operative in accordance with a further embodiment of the disclosed technique. In procedure 350, the characteristics of a cellular phone (i.e., the cellular phone upon which the dynamic mobile client is installed) are discovered and stored as a profile report. With reference to FIG. 2, dynamic mobile client 160 discovers the characteristics of cellular phone 152 as further detailed herein below with reference to FIG. 8. Dynamic mobile client 160 creates a profile report for cellular phone 152 and saves the characteristics of cellular phone 152 on the profile report.

In procedure 352, the profile report of the cellular phone, containing the characteristics of the cellular phone, is sent to a cellular-application intermediate web server (i.e., mobile application server). With reference to FIG. 2, dynamic mobile client 160 sends the profile report of cellular phone 152 to mobile application server 154.

In procedure 354, a web access request is sent to the mobile application server. With reference to FIG. 2, dynamic mobile client 160 sends a web access request to mobile application server 154. The web access request corresponds to input coming from the cellular user (i.e., the cellular user employs keypad 156 to attempt to access the web after which dynamic mobile client 160 generates a corresponding web access request).

In procedure 356, at least one customized mobile application page, adapted to match the characteristics of the cellular phone, is received by the dynamic mobile client from the mobile application server. With reference to FIG. 2, dynamic mobile client 160 receives at least one customized mobile application page, adapted to match the characteristics of cellular phone 152, from mobile application server 154. The adapted application page corresponds to the web access request of the dynamic mobile client. In procedure 358, the customized mobile application page is presented to the cellular user by employing the screen on the cellular phone. With reference to FIG. 2, dynamic mobile client 160 presents the adapted customized mobile application page by employing screen 208 of cellular phone 152.

In procedure 360, user input (e.g., from keypad 156) is received by the dynamic mobile client, and directed to the mobile application server. With reference to FIG. 2, the cellular user navigates through and within the adapted customized mobile application page and can provide input for dynamic mobile client 160 (e.g., the cellular user enters credit card details or the cellular user navigates to a different customized mobile application page, linked by the currently presented customized mobile application page). The user input is directed to mobile application server 154 (e.g., a web access request, corresponding to the different customized mobile application page, linked by the currently presented customized mobile application page).

When the user input refers to dynamic data respective of the currently presented customized mobile application page, procedure 362 follows procedure 360. In procedure 362, dynamic data respective of the currently presented customized mobile application page is received by the dynamic mobile client from the mobile application server. With reference to FIG. 2, mobile application server 154 provides the dynamic data (i.e., obtained from the external source or from the internal parameter), for dynamic mobile client 160. Dynamic mobile client 160 presents the dynamic data, provided by mobile application server 154, to the cellular user.

When the user input relates to a request for a different customized mobile application page, procedures 356 and 358 are performed after procedure 360. Procedures 356 to 360 represent a first loop (i.e., customized mobile application pages loop), and procedures 360 and 362 represent a second loop (i.e., dynamic data loop). A combination of performing the first loop and the second loop is repeated for as long as the cellular user continues to navigate through the application.

Reference is now made to FIG. 8, which is a schematic illustration of a method for discovering the characteristics of a cellular phone, operative in accordance with another embodiment of the disclosed technique. In procedure 400, a set of characteristics of a cellular phone is retrieved from the cellular phone. With reference to FIG. 2, dynamic mobile client 160 retrieves a set of characteristics of cellular phone 152 by querying the operating platform of cellular phone 152. For example, in a Java ME platform, dynamic mobile client 160 presents the following query:

system.getproperty (“microedition.platform”);

Dynamic mobile client 160 retrieves the user agent string (i.e., a unique identifier string for that particular type of cellular phone) of the cellular phone.

Other examples of such queries are character encoding (“microedition.encoding”), current locale (“microedition.locale”), such as Dutch-Holland, supported configuration of the cellular phone (“microedition.configuration”), supported profile of the cellular phone (“microedition.profile”), and the like. It is noted that, although the example set forth herein above relates to a Java ME platform, other similar queries are presented to other platforms for retrieving cellular phone characteristics from the cellular phone itself.

In procedure 402, the availability of supporting features of the cellular phone is retrieved from the cellular phone. With reference to FIG. 2, dynamic mobile client 160 retrieves the availability of supporting features of cellular phone 152 from cellular phone 152. Dynamic mobile client 160 queries the operating platform of cellular phone 152 and obtains information respective of which support features are available on cellular phone 152. For example, in Java ME, dynamic mobile client 160 presents the following query:

system.getproperty (“microedition.io.file.Fileconnection.version”);

Dynamic mobile client 160 receives the version of the Java ME file connection API.

Other examples of such supported features are a personal information management of cellular phone 152 (“microedition.pim.version”), a list of communication ports available on cellular phone 152 (“microedition.commports”), a Short Message Service Center (SMSC) address used for sending messages by cellular phone 152 (“wireless.messaging.sms.smsc”), a version of the multimedia API (“microedition.media.version”), and the like. It is noted that, although the example set forth herein above relates to a Java ME platform, other similar queries are presented to other platforms for receiving cellular phone supported features from cellular phone 152. In procedure 404, benchmark tests are executed on the cellular phone for determining the availability of a certain feature on the cellular phone. With reference to FIG. 2, dynamic mobile client 160 executes benchmark tests on cellular phone 152 for determining the availability of a certain feature on cellular phone 152. For example, in Java ME, dynamic mobile client 160 enters:

“try
{Class.forName(“com.name.of.package.NameOfClassToTest”);}
catch (ClassNotFoundException e)”

When dynamic mobile client 160 executes this code, it is not expected to reach the ‘catch’ block if the tested class (‘NameOfClassToTest’) exists. If, however, the class does not exist, then a ClassNotFoundException is thrown. Dynamic mobile client 160 performs this test for one class out of each features package it tests.

In procedure 406, further benchmark tests are executed on the cellular phone for determining the capabilities and the performance of the cellular phone. With reference to FIG. 2, dynamic mobile client 160 executes a series of benchmark tests on cellular phone 152. For example, dynamic mobile client 160 discovers the total amount of memory of cellular phone 152 by querying the system via a system call. Cellular phone 152 provides dynamic mobile client 160 with the memory limit contained therein. Dynamic mobile client 160 consumes the memory limit reported and one unit of memory in excess. When an “OutOfMemory” error occurs, dynamic mobile client 160 terminates the memory verification test. When an “OutOfMemory” error does not occur, dynamic mobile client 160 consumes another unit of memory. Dynamic mobile client 160 repeats the process until an “OutOfMemory” error occurs at which point dynamic mobile client 160 terminates the memory verification test and retains the result, which is a precise value for the amount of available memory on the cellular phone.

Another example of a benchmark test is for discovers the Central Processing Unit (CPU) performance of cellular phone 152. Dynamic mobile client 160 measures the time taken for the CPU of cellular phone 152 to add two integers many times over (e.g., the time taken for the CPU to calculate the addition of 42 and 35, 100 times). Dynamic mobile client 160 further measures the time taken for the CPU of cellular phone 152 to multiply two integers many times over, and the time taken for the CPU of cellular phone 152 to divide an integer by another integer many times over. Other cellular phone properties, discovered by similar benchmark tests, are graphics memory, graphics processor performance (e.g., by image creation test, image drawing tests, lines drawing test, rectangle filling test, a refresh screen test, and an image movement), and the like.

In procedure 408, the dynamic mobile client generates a profile report for the cellular phone, and stores the discovered cellular phone characteristics and capabilities on the cellular phone profile report. With reference to FIG. 2, dynamic mobile client 160 generates a profile report for cellular phone 152 and stores the discovered characteristics and capabilities of cellular phone 152 on the profile report. It is noted that, the profile report is generated on the first connection of dynamic mobile client 160 to mobile application server 154, and additionally at predetermined time intervals (e.g., once a month) and is sent to mobile application server 154 (FIG. 2).

It will be appreciated by persons skilled in the art that the disclosed technique is not limited to what has been particularly shown and described hereinabove. Rather the scope of the disclosed technique is defined only by the claims, which follow.

1. Apparatus for presenting a customized mobile application page on a mobile device, the apparatus comprising:
a communication interface coupled with a communication interface of a mobile application server; and
a user interface functionality manager, coupled with said communication interface, for providing the graphics and displayed data of said customized mobile application page to the display of said mobile device and for implementing an event-action list of each of a plurality of components of said customized mobile application page,
wherein said user interface functionality manager sends a web access request to said mobile application server via said communication interface, according to input received from a user of said mobile device, said communication interface receives said customized mobile application page from said mobile application server, said customized mobile application page corresponds to said web access request, said received customized mobile application page is adapted according to the characteristics of said mobile device, said communication interface provides said adapted customized mobile application page to said user interface functionality manager.

2. The customized page presenting apparatus of claim 1, further comprising an adaptor, coupled with said communication interface and with said user interface functionality manager, said adaptor complementary adapting said customized mobile application page according to the characteristics of said mobile device.

3. The customized page presenting apparatus of claim 1, wherein said user interface functionality manager discovers the characteristics of said mobile device and sends the characteristics of said mobile device to said mobile application server via said communication interface.

4. The customized page presenting apparatus of claim 3, wherein the characteristics of said mobile device are selected from the list consisting of:
screen resolution;
screen orientation;
input devices;
UserAgent string;
character encoding;
current locale;
supported configuration;
list of communication ports;
supported video formats;
supported image formats;
supported functionalities;
total amount of memory;
graphics memory; and
CPU performance.

5. The customized page presenting apparatus of claim 1, wherein said user interface functionality manager receives additional user input, and directs said additional user input to said mobile application server via said communication interface.

6. The customized page presenting apparatus of claim 1, wherein said user interface functionality manager receives inner event data and directs said inner event data to said mobile application server via said communication interface.

7. The customized page presenting apparatus of claim 1, wherein said communication interface receives dynamic data respective of said customized mobile application page, adapted according to the characteristics of said mobile device, from said mobile application server and provides said dynamic data to said user interface functionality manager.

8. The customized page presenting apparatus of claim 3, wherein said user interface functionality manager discovers the characteristics of said mobile device by retrieving a set of characteristics of said mobile device from said mobile device, retrieving the availability of supporting features of said mobile device from said mobile device, executing benchmark tests on said mobile device for determining the availability of a certain feature on said mobile device, and executing further benchmark tests on said mobile device for determining the capabilities and the performance of said mobile device.

9. Method for presenting a customized mobile application page on a mobile device, the method including the procedures of:
sending a web access request to a mobile application server;
receiving at least one adapted customized mobile application page from said mobile application server, said at least one adapted customized mobile application page being adapted according to the characteristics of said mobile device, said at least one adapted customized mobile application page including mobile application components, each of said mobile application components including communications protocol and method for communicating with external systems for retrieving respective data stored on said external system, said communications protocol and method further serve as complementary logic for said mobile application component; and
presenting said at least one adapted customized mobile application page by employing said mobile device.

10. The customized page presentation method of claim 9, further comprising the procedure of complementary adapting said customized mobile application page according to the characteristics of said mobile device.

11. The customized page presentation method of claim 9, further comprising the procedure of discovering the characteristics of said mobile device and sending the characteristics of said mobile device to said mobile application server.

12. The customized page presentation apparatus of claim 11, wherein the characteristics of said mobile device are selected from the list consisting of:
screen resolution;
screen orientation;
input devices;
UserAgent string;
character encoding;
current locale;
supported configuration;
list of communication ports;
supported video formats;
supported image formats;
supported functionalities;
total amount of memory;
graphics memory; and
CPU performance.

13. The customized page presentation method of claim 9, further comprising the procedure of receiving additional user input from an input interface of said mobile device, and directing said additional user input to said mobile application server.

14. The customized page presentation method of claim 9, further comprising the procedure of receiving dynamic data respective of said customized mobile application page from said mobile application server and presenting said dynamic data by employing said mobile device.

15. The customized page presentation method of claim 11, wherein said procedure of discovering the characteristics of said mobile device is performed by employing the sub-procedures of:
retrieving a set of characteristics of said mobile device from said mobile device;
retrieving the availability of supporting features of said mobile device from said mobile device;
executing benchmark tests on said mobile device for determining the availability of a certain feature on said mobile device; and
executing further benchmark tests on said mobile device for determining the capabilities and the performance of said mobile device.

16. The customized page presentation method of claim 9, further comprising the procedure of installing a dynamic mobile client onto said mobile device, said procedure of installing is performed before said procedure of sending a web access request.

17. Apparatus for adapting a customized mobile application page and providing it to a mobile device, the apparatus comprising:
a communication interface coupled with a communication interface of said mobile device;
an administrator, coupled with said communication interface, for retrieving said customized mobile application page from a database, said customized mobile application page corresponds to a web access request; and
an adaptor for adapting said customized mobile application page according to the characteristics of said mobile device,
wherein said communication interface receives said web access request from said mobile device, said communication interface provides said web access request to said administrator, said administrator provides said customized mobile application page to said adaptor, said adaptor provides said adapted mobile application page to said mobile device via said communication interface.

18. The adapting apparatus of claim 17, wherein said administrator receives said customized mobile application page from a cellular-application studio, and wherein said administrator stores said customized mobile application page on said database.

19. The adapting apparatus of claim 17, further comprising an integrator coupled with said communication interface, said administrator, and with said adaptor, said integrator communicates with an external system for retrieving complementary logic respective of said customized mobile application page and for retrieving dynamic data respective of said customized mobile application page.

20. The adapting apparatus of claim 19, wherein said integrator communicates with said external system by a employing a communications protocol selected from the list consisting of:
a web service;
a SOAP connection;
an FTP connection;
a Telnet connection;
an SSH connection;
an RMI connection;
a Database query
an LDAP query;
a REST connection;
a Uniform Resource Locator connection (URL);
a Really Simple Syndication (RSS); and
an Extensible Markup Language (XML).

21. The adapting and providing apparatus of claim 17, wherein said adaptor receives said characteristics of said mobile device from said mobile device via said communication interface.

22. The adapting apparatus of claim 17, wherein said communication interface receives said web access request from said mobile device.

23. The adapting apparatus of claim 17, wherein said communication interface receives input from said mobile device.

24. The adapting apparatus of claim 23, wherein said input is selected from the list consisting of:
a data request;
a mobile application page request; and
an event.

25. Method for adapting a customized mobile application page according to the characteristics of a mobile device and for providing the customized mobile application page to the mobile device, the method comprising the procedures of:
receiving a web access request from said mobile device;
retrieving a customized mobile application page from a database, said customized mobile application page corresponds to said web access request, said customized mobile application page including mobile application components, each of said mobile application components including communications protocol and method for communicating with external systems for retrieving respective data stored on said external system, said communications protocol and method further serve as complementary logic for said mobile application component;
adapting said customized mobile application page according to the characteristics of said mobile device; and
providing said customized mobile application page to said mobile device.

26. The adaptation method of claim 25, further comprising the procedure of receiving said customized mobile application page from a cellular-application studio, and storing said customized mobile application page on said database, said procedure of receiving said customized mobile application page from a cellular-application studio being performed prior to said procedure of receiving a web access request from said mobile device.

27. The adaptation method of claim 25, further comprising the procedure of communicating with an external system for retrieving complementary logic respective of said customized mobile application page and for retrieving dynamic data respective of said customized mobile application page.

28. The adaptation method of claim 27, wherein said procedure of communicating with said external system is performed by a employing a communications protocol selected from the list consisting of:
a web service;
a SOAP connection;
an FTP connection;
a Telnet connection;
an SSH connection;
an RMI connection;
a Database query
an LDAP query;
a REST connection;
a Uniform Resource Locator connection (URL);
a Really Simple Syndication (RSS); and
an Extensible Markup Language (XML).

29. The adaptation method of claim 25, further comprising the procedure of receiving said characteristics of said mobile device from said mobile device.

30. The adaptation method of claim 25, further comprising the procedure of receiving input from said mobile device.

31. The adaptation method of claim 30, wherein said input is selected from the list consisting of:
a data request;
a mobile application page request; and
an event.

32. Method for producing a customized mobile application page, the method comprising the procedures of:
receiving instructions for generating a new customized mobile application page and the design thereof;
receiving the type of a new mobile application component of said customized mobile application page, said component type is of a predetermined list of component types;
receiving the design of said new mobile application component;
associating communication protocol and method to said new component;
associating complementary logic and data respective of said new component, to said new component in accordance with said communications protocol and method; and
receiving the behaviour of the new component,
wherein said procedure of receiving the type of a new component, receiving the design, associating communication protocol, associating complementary logic, and receiving the behaviour are repeated for each of the components of said customized mobile application page.

33. The production method of claim 32, wherein the type of said new mobile application component is selected from the list consisting of:
a label type component;
a link type component;
a ticker type component;
an item-list type component;
a dropdown list box type component;
a media player type component;
a matrix table type component;
a radio button type component;
a checkbox type component;
a command button type component;
an image type component; and
a textbox type component.

34. The production method of claim 32, wherein said behaviour of said new component being determined by an event action list which includes at least one action for each of a plurality of predetermined events, associated with said component.

35. The production method of claim 34, wherein said predetermined event of said event action list is selected from the list consisting of:
a mouse over event;
a focus event;
a click event;
a change event;
a component load event;
a page load event;
a page unload event;
a container click event;
a has next page type event;
a has prey page type event;
a timer event; and
an error event.

36. The production method of claim 34, wherein said action of said event action list is selected from the list consisting of:
calling an external service;
displaying a text box;
requesting a predetermined customized mobile application page;
displaying tool-tips;
bringing up a popup box;
refreshing a specific component;
setting a value of a session parameter;
clearing pages from the client cache repository;
going a page back in the history stack;
changing a component value;
changing a component design attribute; and
activating an API call.

37. The production method of claim 32, further comprising the procedure of storing said new completed customized mobile application page on a mobile application server.
